(19) United States
(12) Patent Application Publication
(10) Pub. No.: US 2026/0277691 A1
(43) Pub. Date: Sep. 17, 2026

(54) AGENTIC WORKFLOW FRAMEWORK

(71) Applicant: SAP SE, Walldorf (DE)

(72) Inventors: Abhishek KUMAR, Bangalore (IN); Vikrant PATIL, Bangalore (IN)

(21) Appl. No.: 19/080,264

(22) Filed: Mar. 14, 2025

(51) Int. Cl. G06F 9/50

(52) U.S. Cl. CPC G06F 9/5038

(57) ABSTRACT

A system and method including receiving a signal to initiate execution of a modeled workflow including at least one artificial intelligence (AI) task to perform at least one activity towards a specified result and the AI task being assigned to an artificial intelligence (AI) agent; determining a current context for the modeled workflow; determining to call the AI agent to execute the AI task; determining by the AI agent, based in part on the current context, to call a large language model (LLM) to execute the at least one activity of the AI task, a prompt for the LLM model being derived from at least attributes of the AI task and the AI agent; and determining by the AI agent, based in part on a result of the call to the LLM model, at least one next action to perform towards an achievement of the result.

### BACKGROUND

Some modern applications and modelling systems provide mechanisms to model workflow processes, including processes having aspects thereof performed by humans. Typically, such applications and systems can be used to model workflow processes including multiple steps. In some instances, one or more of the steps of the workflow process may not be known during the modelling of the workflow but may be determined at an execution time (i.e., runtime) of the workflow process based on decisions of a human actor and/or changes in the context of the workflow process. In some aspects, these applications and systems accommodate unstructured or “ad-hoc” decision making performed by human actors.

Increasingly, artificial intelligence (AI) agents have been proposed and created that are capable of leveraging large language models (LLMs) to autonomously perform tasks for the benefit of a user or another system or application. In some aspects, these AI agents can perform a variety of functionalities such as decision making, executing actions, and interacting with external systems, applications, and services.

An agentic framework is desired that intelligently and automatically provides information to autonomous AI agents and orchestrates execution and collaboration between the AI agents and a variety other tasks, including AI tasks and non-AI tasks to achieve the goal(s) of a workflow process.

### BRIEF DESCRIPTION OF THE DRAWINGS

FIG. 1 is an illustrative schematic diagram of some components of an agentic workflow framework, in accordance with an example embodiment herein;

FIG. 2 is an illustrative system architecture at design time for an agentic workflow framework, in accordance with an example embodiment herein;

FIG. 3 is an illustrative system architecture at runtime for an agentic workflow framework, in accordance with an example embodiment herein;

FIG. 4 is an illustrative depiction of some aspects of an AI task and an associated AI agent, in accordance with an example embodiment herein;

FIG. 5 is an illustrative depiction of AI tasks for an agentic workflow including a deterministic flow, in accordance with an example embodiment herein;

FIG. 6 is an illustrative depiction of AI tasks for an agentic workflow including a non-deterministic flow, in accordance with an example embodiment herein;

FIG. 7 is an illustrative depiction of AI tasks for an agentic workflow including a parallelization of some activities, in accordance with an example embodiment herein;

FIG. 8 is an illustrative depiction of AI tasks for an agentic workflow including a feedback loop, in accordance with an example embodiment herein;

FIG. 9 is an illustrative depiction of AI tasks for an agentic workflow including delegation and a feedback loop, in accordance with an example embodiment herein;

FIG. 10 is an illustrative depiction of AI tasks for an agentic workflow including parallelization within a non-deterministic flow, in accordance with an example embodiment herein;

FIG. 11 is an illustrative process flow related to an agentic workflow framework, according to an example embodiment;

FIG. 12 is an illustrative representation of an agentic workflow related to aspects of a hiring process, in accordance with an example embodiment herein;

FIG. 13 is an illustrative representation of an agentic workflow including aspects related to a document drafting process, in accordance with an example embodiment herein;

FIG. 14 is an illustrative sequence diagram for the agentic workflow of FIG. 13, in accordance with an example embodiment herein; and

FIG. 15 is an illustrative block diagram of a cloud-based system, in accordance with an example embodiment herein.

### DETAILED DESCRIPTION

The following description is provided to enable any person in the art to make and use the described embodiments. Various modifications, however, will be readily apparent to those in the art.

Embodiments may provide a framework for integrating Generative Artificial Intelligence (Gen AI) capabilities into applications and services including workflow or case modelling and execution. As used herein, a workflow or case refers to a process requiring one or more steps or tasks to be performed to achieve a specified goal of the workflow. In some instances, one or more of the steps and the order of performing one or more of the steps might not be known during a modelling of the workflow (i.e., before an execution of the workflow or at a design time). All of the specific steps and the specific order to perform the steps might not be known in advance since at least some steps and aspects of the order of performing the steps can depend on changing aspects related to the workflow. At a time the workflow is executed (i.e., at a run time), decisions regarding the tasks to be performed and the order of performing those tasks can be made in response to evolving aspects related to the workflow. Some of the evolving aspects related to the workflow can include a context for the workflow, changes to the process (e.g., a current lifecycle of the process, etc.), and interactions with other activities and actors having an impact on the process. In some embodiments herein, the decision-making entity that determines the tasks and order thereof in a workflow to achieve the desired goal of the workflow can be an AI agent that uses LLMs to make intelligent, autonomous decisions regarding the workflow tasks.

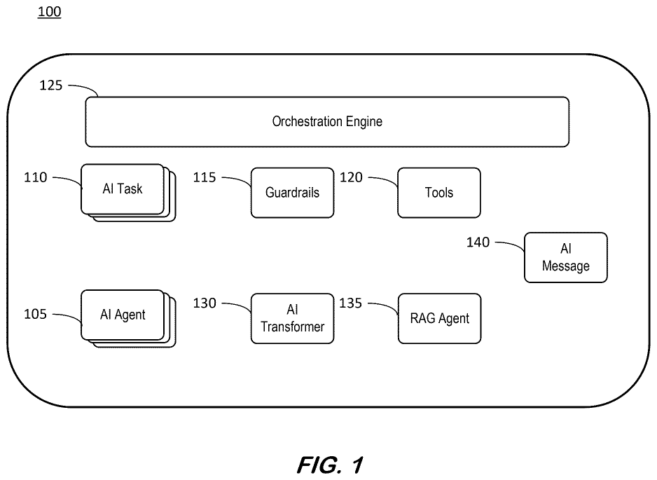

FIG. 1 includes an illustrative block diagram 100, in accordance with an example embodiment herein. Block diagram 100 includes a representative depiction of some components of an agentic workflow framework in some embodiments. Shown in FIG. 1 are AI agents 105 that encompass a LLM capability that is used to perform one or more AI tasks 110. AI agents 105 are assigned to AI tasks 110 and execute their associated AI tasks. Attributes defined for an AI agent 105 can include a role (string value) that specifies an objective function to be carried out by the AI agent, a description (string value) that can include a descriptive explanation of the AI agent, and some knowledge (string value) for the particular type of AI agent that specifies the expertise of the AI agent. The knowledge specified for each AI agent is specific for the role of the AI agent and related to the work the AI agent will be performing. Additional attributes defined for an AI agent in some embodiments includes a collaborate attribute (Boolean) that specifies whether the AI agent calls other AI agents for more information, a specified maximum number (integer) of times the AI agent can call another AI agent, a LLM model the AI agent is to use in making its decisions, and a specification of the different properties the AI agent is to use to call an LLM (e.g., temperature, etc.). In some embodiments herein, the AI tasks and activities performed or executed by an AI agent are role based.

AI tasks 110 are defined by attributes including a name (string) of the AI task, a subject (string) that includes a parameterized description that forms a unique description for the AI task, an assignee (string) that specifies the AI agent to which the AI task is assigned, a goal (string) that is a parameterized entity provided to the assigned AI agent to perform or otherwise execute specific work, an output (string) that is a parameterized entity that specifies an expected output of the AI task that is provided to an AI agent so the AI agent can provide a work result in the specified format, and a streaming value (Boolean) specifies whether intermediate results from the LLM are passed on to a streaming (e.g., Kafka, etc.) channel.

In some instances, workflow processes can be defined in very granular steps, where the granular steps are each represented by an AI task 110 having attributes specified to capture the relevant aspects of each respective step. As such, multiple different AI agents 105 can each be assigned to a specific AI task 110 to perform a specific, granular part of the workflow. For example, the knowledge specified for each AI agent 105 is specific for the role of that AI agent and related to the activities they will be performing.

Referring to FIG. 1, for an agentic workflow herein, guardrails 115 are the constraints defined as expressions that govern the life cycle event(s) of the AI task coming from an AI agent. AI agents can have access to multiple tools 120, where the tools include the different activities that can be executed at a runtime. Examples of some tools include a service task, a process task, and a script task.

Orchestration engine 125 understands the AI tasks and what semantics it is to pass to the AI agents and other entities and further defines the execution flow and the exchange of data between different tasks and other entities to efficiently and accurately manage the execution of the AI tasks.

AI transformer 130 acts as an intermediary between different entities that expect different formats or configurations of inputs and outputs so that the different entities can collaborate to achieve the overall goal or objective of the workflow process. AI Agents herein might interact with strongly typed software modules (e.g., services, APIs, etc.) that have well-defined input and output interfaces. These software modules may be modelled as conventional case runtime tasks (e.g., a process management service, framework, application, etc.). AI Transformer 130 operates as an intermediary between these case tasks and AI tasks to facilitate information exchanges therebetween. For example, the AI transformer can receive an output of an AI task (string) and convert it to the expected input (typed) format of a conventional case task, as well as receiving an output from a conventional case task and converting it to string format suitable for the consumption by an AI task. In some embodiments, AI transformer 130 uses meta data information of case tasks input/output interfaces and calls LLMs to convert strings to the desired format and vice versa. In some embodiments, AI Transformer 130 can perform exception handling. For example, exceptions can be parsed to extract the information from a stack trace, further enriched and passed to an AI Agent. The particular action performed in response to the detection of an error or exception depends on an exception strategy defined for an AI task (e.g., it may fail gracefully, start a human task or let an LLM decide a next course of action). In some embodiments, the AI transformer can store all of the interaction information exchanged between case tasks and AI tasks, for example, in cooperation with RAG agent 135 to continuously learn and adapt.

AI message object 140 operates to store all of the information passed to the LLM, including the prompts created and passed to the LLM and the values received from the LLM. AI message objects are used to store all of such information (i.e., context data), which can be made available for every AI agent throughout the case execution time frame so that an accurate context can be created for a next call of the LLM.

In some aspects herein, RAG agent 135 may operate to store all of the information related to the activities and interactions in a workflow process. Such information might include the activities used by AI agents to perform a task, the interactions between AI Agents and AI tasks; and the errors/exceptions and their corresponding resolution action(s). Also, the context for a workflow is stored in the RAG agent, as well as the AI messages being created from the output of the LLM. In some embodiments, the RAG agent stores the information handled thereby in a vector database, wherein this information might be retrieved and used by the RAG agent to enrich the prompts used to call LLMs. In some embodiments, information stored by the RAG agent can be used to further run a machine learning algorithm to help an AI agent to choose a best next step to execute, including, for example, to suggest transformation of strings to typed interface metadata for non-AI case tasks and vice versa.

In some embodiments herein, a system prompt can be created using the specified role, description, and knowledge attributes of an AI agent. For example, a user prompt can be created using the goal and output attributes of AI task. Furthermore, an assistant prompt can be created using the attributes of other AI Agents (e.g., role, description, and knowledge attributes) and case tasks (e.g., name and description attributes) available as part of the case model. By combining at least some aspects of system, assistant and user prompts, a final prompt can be generated and provided as input to a LLM to generate a desired output. An AI agent decides, based on the result of LLM call, whether to activate and execute other AI tasks for collaboration and other case (non-AI) tasks to get information from other software code (e.g., call an API, call a service or platform, etc.).

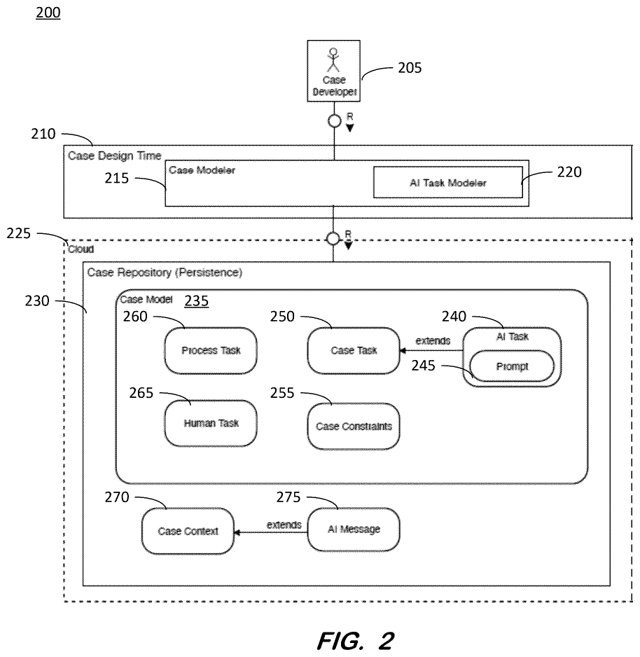

FIG. 2 is an illustrative system architecture 200 at design time for an agentic workflow framework, in accordance with an example embodiment herein. System 200 includes a user interface (UI) that presents representations of a case design time 210 to model workflow processes. In some embodiments, the UI interfaces with a cloud based service or platform 225 that provides a repository or persistence 230 that stores a case model 235 created to specify one or more tasks to be performed to achieve a specified goal of the workflow process. In some embodiments, features of an existing system, application, or service might be reused and extended to support the AI agents, AI tasks, and other features of an agentic workflow herein. In some aspects, AI agents and AI tasks disclosed herein might be integrated into a process management framework. For example, features of or related to a Case Management Model and Notation (CMMN) system, application, service, framework or platform might be reused or leveraged and extended (e.g., evolved) to integrate with the agentic workflow components and features disclosed herein. In some aspects, the AI agents and AI tasks disclosed herein might efficiently integrate with a CMMN framework since, for example, a CMMN framework is well-suited for modelling and automating unstructured workflows or processes (e.g., an ad-hoc process), where knowledge workers have flexibility to actively make decisions and plan the order of actions during an execution runtime to achieve a specified, desired goal. The CMMN framework is a declarative (i.e., specifies a desired result) and data-centric (e.g., provides extensive context information/data for decision-making) modelling process ideally suited for ad-hoc, case-driven processes where the particular activities and the ordering thereof may differ on a case by case basis. As such, a CMMN framework may be particularly useful for combining with AI agents and AI tasks herein, as the AI output is non-deterministic, and the outcome of each AI task performed by an AI agent may change.

In some instances, various concepts and features of a CMMN (or other process management) system, application, service, framework or platform might include a case plan model representing the structure of a case (or workflow), where each case instance contains a single “case file” comprising a central case repository (i.e., persistency) for all case-related data that can be dynamically modified by case workers. The case plan model can include the features of “tasks” that represent a basic unit of work, including for example three types of tasks comprising a human task that is performed by a human actor, a process task that can call a process, and a case task that may call other tasks; “stages” that are used to group related tasks and other elements (e.g., other stages, tasks, and milestones) and represent a phase in a case lifecycle; “milestones” that are used to mark significant points or achievements within a case and to enable evaluation and tracking of the progress of the case; and “event listeners” that define the flow and behavior of a case by monitoring for the occurrence of events (e.g., achievement of a milestone, a user interaction, etc.) and executing a predefined action or next step when the event is triggered, as well as “sentries” that are used to define conditions that control the activation and termination of tasks and stages, including entry criteria and exit criteria that need to be met for the associated elements to be activated or terminated, respectively; “case file items” that include all data and data structures associated with a case file, where case file items can be referenced and manipulated by tasks and other elements and are stored in the case file; and “roles” that define the participants involved in the case, including specifying who is responsible for performing tasks and making decisions in a case (or workflow process). Each of these features of a CMMN (or other) system may perform in its known and understood manner to provide and support mechanisms that enable the modelling and execution of conventional (i.e., non-AI enabled) tasks. In some aspects, key features of the CMMN framework include its declarative nature, the case file, an orchestrator to manage tasks, a case repository that stores all case context information and data, and the sentries (i.e., the entry criteria and exit criteria) associated with a case.

Returning to FIG. 2, case model 235 is shown as including representations of an AI task 240 that will provide a prompt 245 to a LLM to accomplish its (sub-)goal, as well as conventional (i.e., non-AI) case task 250, case constraints 255, process task 260, and human task 265 that is performed by a human actor. Additionally, case context 270 is extended to support and cooperate with AI message 275. The UI provides an interactive mechanism for user 205 to provide inputs to define and specify the various entities of case model 235 via a case modeler 215 related to the non-AI entities and an AI task modeler 220 associated with and configured to define and manipulate the AI entities disclosed herein (e.g., AI tasks, AI agents, AI transformer, etc.). In some embodiments, functionality for the case modeler and the AI task modeler might be provided by a same or common entity.

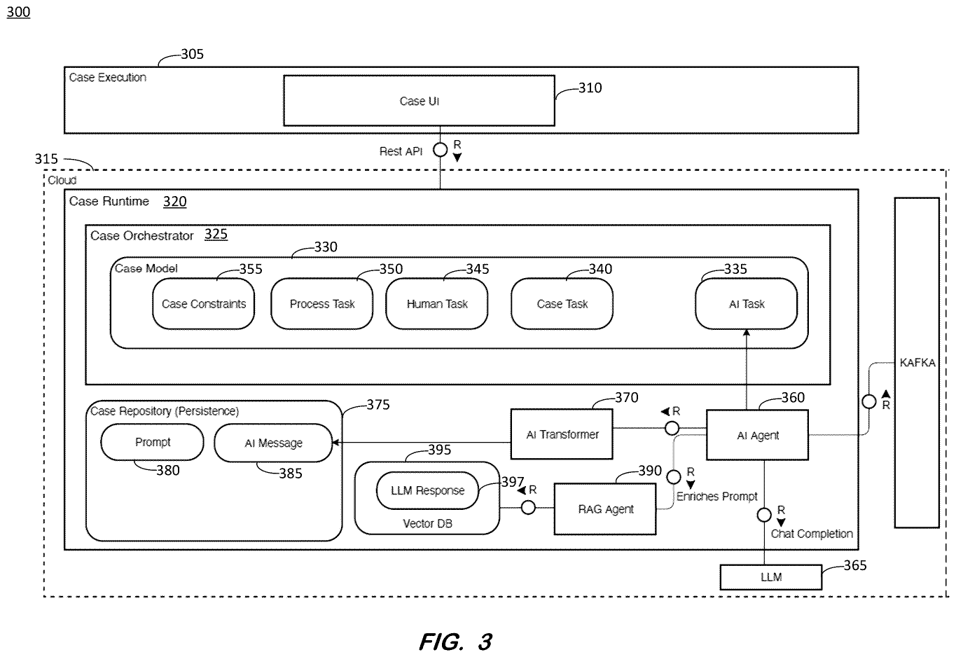

FIG. 3 is an illustrative architecture for a system 300 at runtime for an agentic workflow framework, in accordance with an example embodiment herein. Similar to FIG. 2, in some embodiments features of a CMMN (or other process management) system, application, or service might be reused and extended to support the AI agents, AI tasks, and other features of an agentic workflow disclosed herein. For example, case execution 305 at a runtime supports UI 310 that provides an interactive interface with a cloud-based service, application, platform, or system 315 that provides and performs activities related to a case modelled during a design time. Case runtime 320 supports a case orchestrator 325 that manages and executes actions and interactions of AI task 335, as well as conventional (i.e., non-AI) case task 340, human task 345, process task 350, and case constraints 355 of case model 330. In some aspects, the case task 340, human task 345, process task 350, and case constraints 355 may operate as understood for a conventional CMMN (or other) system, application, or service. Notably, orchestrator 325 may be evolved, extended, or otherwise configured to also mange workflow process interactions and execution involving AI task 335.

At runtime, orchestrator 325 may execute case task 340, human task 345, and process task 350 in reply to inputs via UI 310. Concerning AI task 335, executions related thereto further rely on the autonomous decision-making of AI agent 360. Orchestrator 325 might invoke an execution of AI task in response to a human initiated trigger, an API trigger, or other service or application initiating mechanisms(e.g., messages, signals, etc.). A call to execute AI task 335 operates to cause AI agent 360 assigned to that task to generate a prompt that is provided to LLM 365, where a result from the LLM is used by AI agent 360 to complete to task defined by AI task 335. In some aspects, contextual information related to a current context and other information related to the present workflow process can be retrieved from, for example, vector database 395 by RAG agent 390 wherein such information can be used, alone and in conjunction with other information, to enrich the prompt provided to LLM 365. In some instances, past LLM responses 397 might be stored in the vector database 395 and used by AI agent 360 to generate a prompt for LLM 365, wherein the AI agent “learns” to generate improved prompts based on, at least, some of the previous LLM responses 397.

In some aspects, prompts 380 generated by the AI agent and AI messages 385 generated by AI agents can be stored in a repository or persistence 375. AI messages may be converted between different formats, as needed, by AI transformer 370. As used herein, the AI messages can comprise a native message object that is part of the case runtime global and local context that represents the input and output messages of AI tasks and AI agents. In some embodiments, an AI message object herein is unique to a combination of a producer AI task/AI agent and a consumer AI task/AI agent. Properties of an AI message object herein can be specified by, in some instances, a producer, a consumer, a current message, and past message attributes. As an example, the producer (string) attribute is defined to specify a UIID of either a respective producer AI task or AI agent; the consumer (string) attribute is defined to specify a UIID of either a respective consumer AI task or AI agent; the current message (string) attribute captures the latest message to be exchanged; and the past messages (key, value) attribute includes all of the messages of past interactions, where the value parameter is a string and the key parameter is an interaction number. Specification of both the producer and the consumer forms a unique combination.

In some aspects, key features for integrating AI agents and AI tasks disclosed herein into a CMMN (or other process management) framework include AI agent(s), AI task(s), and the orchestrator further configured or enabled to manage AI tasks, AI agents, and the collaboration therebetween. Further features relevant for integrating AI agents into a CMMN (or other process management) system or service can include an AI transformer to facilitate interactions between AI tasks (and other elements), AI message items, and a RAG agent that might be optional features or components in some embodiments.

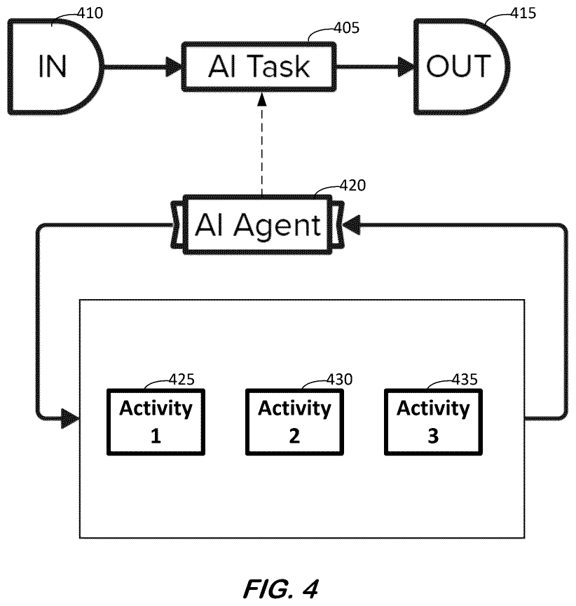

FIG. 4 is an illustrative graphical representation of some aspects of an AI task 405 and an associated AI agent 420, in accordance with an example embodiment herein. The AI task represents activities to be performed to achieve a specific, defined goal. Provided with an input 410, AI task 405 is defined to produce an expected output 415. AI task 405 is, during a design time, assigned to AI agent 420. In some aspects, an AI agent herein encompasses an LLM call wherein prompt(s) are provided dynamically via an orchestration engine (or e.g., orchestrator 325 in FIG. 3) based on defined constraints (e.g. guardrails), the available state of different activities, and values stored as part of orchestration engine memory (e.g., information forming a context for the present workflow process that is stored in a persistence layer or storage device or system). In this manner, an AI Agent herein makes determinations that drive the workflow process based on the result of the LLM call.

In the example of FIG. 4, execution of AI task 405 may be accomplished by AI agent 420 activating and executing one or more of activity 425, activity 430, and activity 435. Depending on information available to AI agent 420 at a time of the execution, AI agent 420 may determine to perform the task defined by AI task 405 by configuring one or more of the activities 425, 430, and 435 in a particular flow pattern. For example, AI agent 420 may determine that based on a current context for the workflow process that the activities should be performed sequentially by executing activity 425, then activity 430 and then activity 435, in contrast to a different runtime when AI agent 420 might determine only activity 430 need be activated and executed to accomplish AI task 405.

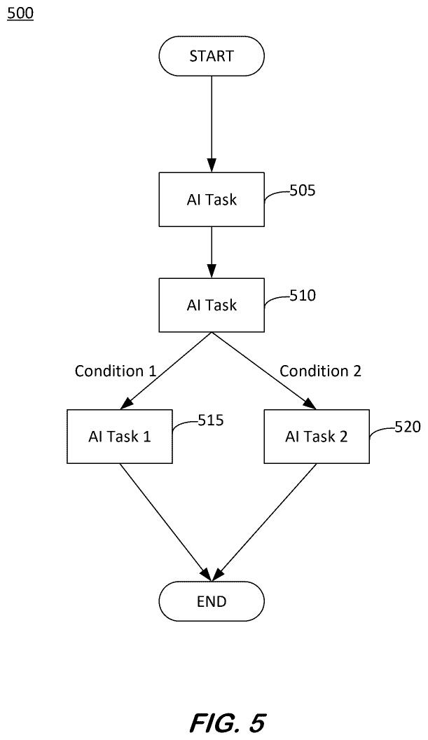

FIGS. 5-10 graphically illustrate various aspects of AI tasks for an agentic workflow, in agreement with some embodiments herein. The different configurations of AI tasks depicted in FIGS. 5-10 are examples of some possible configuration flows for AI tasks collaborating with each other. FIGS. 5-10 are not intended to be an exhaustive presentation of all possible configurations of AI tasks associated with an agentic workflow framework of the present disclosure, but rather exemplary instances thereof.

FIG. 5 is an illustrative depiction of AI task flow 500 for an agentic workflow including a deterministic flow, in accordance with an example embodiment herein. Flow 500 conveys a simple flow pattern. In this example flow, an output of AI task 505 is the input for AI task 510, where each AI task is assigned to an AI agent (not shown). The AI agent for AI task 510 performs some work and the output of AI task 510 is defined as Condition 1 and Condition 2, where the result of an evaluation of each condition defines a next activity/task to call. In this example, the output of AI task 510 is two conditions, where Condition 1 calls AI Task 515 and Condition 2 calls AI Task 520. This flow pattern of FIG. 5 comprises a completely deterministic state.

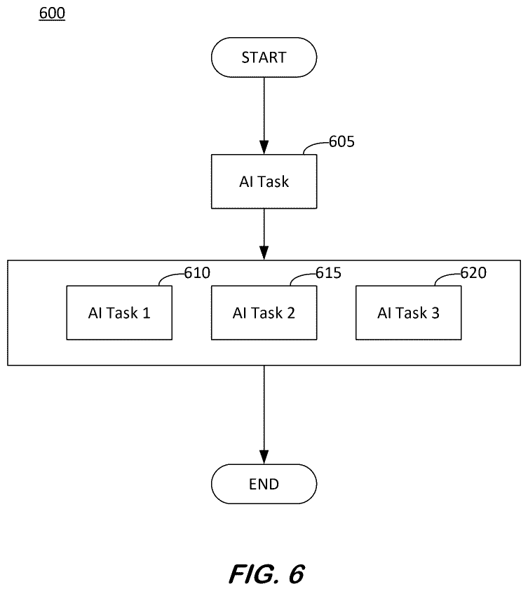

FIG. 6 is an illustrative depiction of AI task flow 600 for an agentic workflow including a non-deterministic flow, in accordance with an example embodiment herein. The workflow of FIG. 6 includes AI task 605 and multiple AI tasks (610, 615, and 620) that can be executed based on the output of AI task 605. For this example, a case orchestrator operates to manage and otherwise direct the configuration of the AI tasks. As an example use-case, a customer complaint is received that initiates the workflow of FIG. 6. AI task 605 automatically analyzes that customer complaint and based on a determined type of complaint, based on the sentiment of the complaint or what type of complaint it is, the orchestrator can call one of the three AI tasks 610, 615, and 620. AI task 605 will decide which AI task (610, 615, and 620) to call, wherein the result of the decision will be stored and forms part of the context for the runtime of the present example. In this example, AI task 605 is assigned to an AI agent (not shown) that receives a complaint and executes some sentiment analysis thereon. Here, the analysis does not simply result in deterministic conditions. In this example, the AI tasks 610, 615, and 620 can be modeled as potential tasks primarily based on the defined goal of the available (i.e., potential or candidate) tasks. In the present example, the AI agent for AI task 605 may understand there are three AI tasks available to work on the present workflow process and if the output of AI task 605 is about a technical review, then execute AI task 610; if the output of AI task 605 is related to a delivery, then perform AI task 615; and if the output is determined to be related to or suitable for a human representative, then AI task 620 is to be activated. In some aspects, the case runtime (e.g., FIG. 3, 320) will provide this context information to the appropriate AI agent and the AI agent will start AI task 605 and further determine which AI task 610, 615, and 620 to execute.

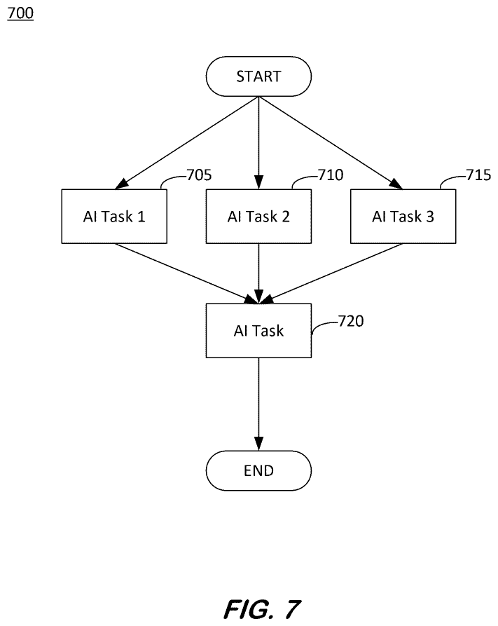

FIG. 7 is an illustrative depiction of AI task flow 700 for an agentic workflow including a parallelization of some activities, in accordance with an example embodiment herein. In FIG. 7, a same input is passed or otherwise provided to each of the three different AI tasks 705, 710, and 715 where AI agents for each of these AI tasks performs different action(s). The outputs from AI tasks 705, 710, and 715 are provided to AI task 720 that aggregates the results. As such, flow 700 includes a parallelization of activities (i.e., activities of AI tasks 705, 710, and 715).

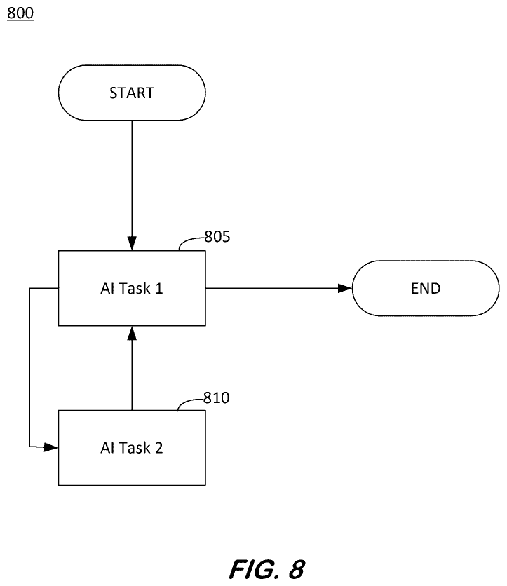

FIG. 8 is an illustrative depiction of AI task flow 800 for an agentic workflow including a feedback loop, in accordance with an example embodiment herein. In this example, there are two AI tasks, including AI task 805 and AI task 810. AI task 805 passes its output to AI task 810 and AI task 810 passes its output to AI task 805. In one use case, flow 800 might represent a document drafting process where AI task 805 includes writing/drafting a document and AI task 810 includes reviewing the draft document. Each of the AI tasks 805 and 810 are assigned to one of two AI agents (not shown). For this example, the case orchestrator (e.g., orchestration engine, etc.) keeps track of the status and activities of these two AI tasks. In this example, when the workflow starts, AI task 805 is started and its corresponding AI agent will write a document and put in the case context for the workflow process. Thereafter, AI task 810 will be started (i.e., activated) when the document is passed to AI task 810. AI Task 810 will execute a review of the document and further put its review of the document into the case context so that the review is available for other task(s) that might need to reference it. Continuing, the case orchestrator will start (i.e., activate) AI task 805 because it now has a review for the document that AI task 805 can consider (e.g., learn from) and rewrite the document to obtain an improved draft document compared to the previous draft. The rewritten document may be further reviewed by AI task 810, wherein the process flow continues iteratively. There is typically some defined constant or condition to stop write and review document loop of FIG. 8. For example, a stop condition might be a specified number of repetitions or some conditions (e.g., if a “review score” is greater than 70%, then this loop should be stopped). The one or more constraints for ending the loop can be defined (e.g., during a design time) and the case runtime will evaluate those constraints and then stop iterating through the loop in accordance with the defined constraints.

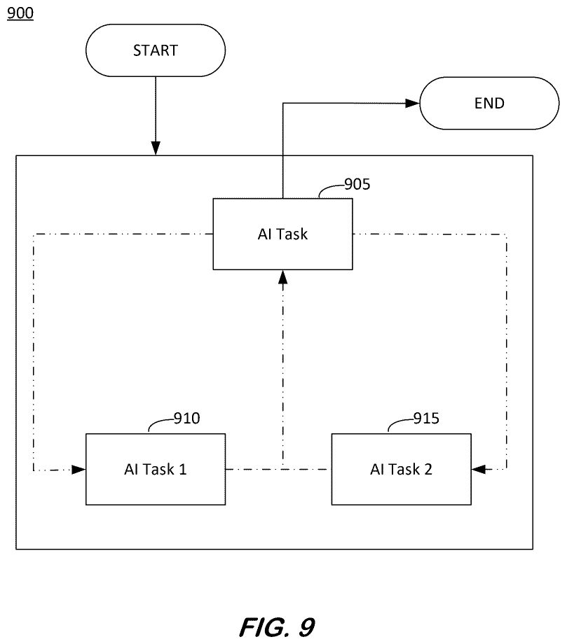

FIG. 9 is an illustrative depiction of AI task flow 900 for an agentic workflow including delegation and a feedback loop, in accordance with an example embodiment herein. In this example, AI task 905 makes a determination to call another AI task, either AI task 910 or AI task 915 (i.e., delegate an action to another AI task). In this example though, the output of AI task 910 and AI task 915 is fed back to AI task 905 in a feedback loopback, with the workflow process of FIG. 9 ending after the output of AI task 905 is generated and saved.

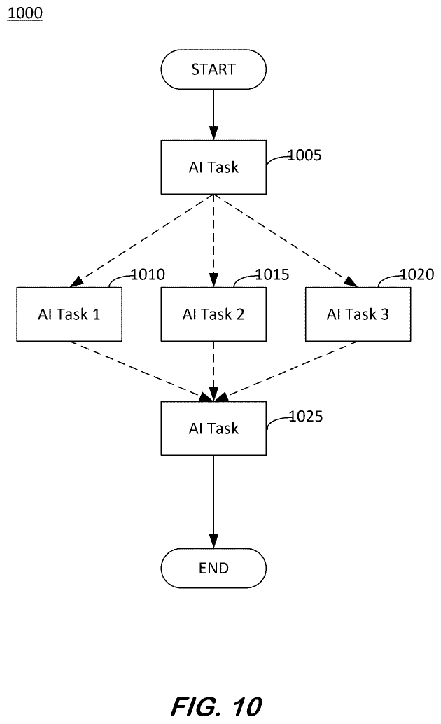

FIG. 10 is an illustrative depiction of AI task flow 1000 for an agentic workflow including parallelization within a non-deterministic flow, in accordance with an example embodiment herein. In some aspects, this example flow of AI tasks is a variation of a parallelization flow configuration. In this example, the output of AI task 1005 might be passed to one or more of AI tasks 1010, 1015, and 1020, depending on a dynamic determination of a next task by the AI agent (not shown) assigned to AI task 1005. In an instance the AI agent determines two or more of the AI tasks 1010, 1015, and 1020 are to perform the next task(s), those two or more AI tasks may be performed in parallel. Which one or more AI tasks will be activated to execute after AI task 1005 cannot be determined or known at design time. According to flow 1000, the outputs of AI tasks 1010, 1015, and 1020 are all passed to AI task 1025.

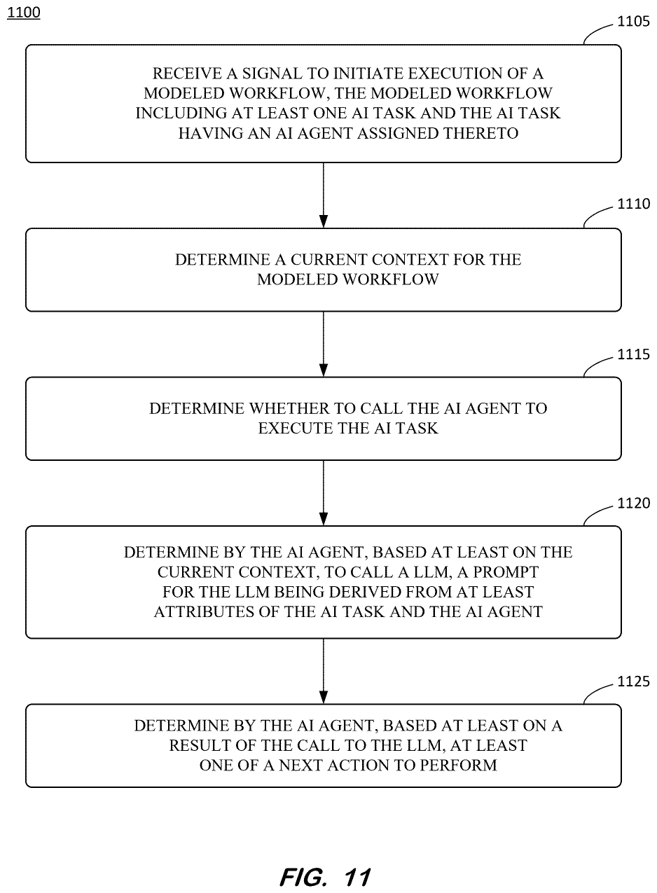

FIG. 11 is an illustrative process flow related to an agentic workflow framework, according to an example embodiment. Process 1100 may be executed by system including at least some of the features and components of an agentic framework disclosed herein, such as, for example, the system depicted in FIG. 3. At operation 1105, a signal to initiate execution of a modeled workflow is received. The signal may be received in response to an action of a user. For example, a user might interact with the system to start execution of a workflow process to achieve a desired result specified for the process. The workflow process can be modeled, to an extent, during a design time as discussed above relative to FIG. 2. Consistent with some embodiments herein, all of the tasks to achieve the result of the workflow process might not be known or otherwise possible to determine and model in advance of an execution of the process due to changing constraints on the process. Accordingly, the modeled workflow can include at least one AI task to perform at least one activity towards the result of the workflow process. As disclosed herein, an AI task can be defined by a number of attributes, including a parameterized “goal” attribute that specifies a scope of the goal for the AI task. Also, the AI task is assigned to an AI that operates to generate a prompt for a LLM to perform one or more actions toward the specified result.

Operation 1110 includes determining a current context for the modeled workflow. The context for the workflow process might include, for example, information related to or indicative of a current state of available tasks (e.g., available, active, complete, etc.), past messages regarding interactions between tasks for previous executions of the workflow process or parts thereof, error and exception handling actions, a lifecycle stage of the workflow process, etc. In some aspects, the context represents/encompasses all the information (i.e., the state of all the variables and objects used by the tasks and expressions) about the workflow process, including all of the documents and all of the variables associated therewith. Some of these items can be used to evaluate the expressions that will make certain task(s) available or active. The context can be evaluated/analyzed by the AI agents herein so they can take some action on a process.

Operation 1115 includes determining whether to call the AI agent assigned to the AI task to execute the AI task. In response to determining to call the AI agent, by an applicable and capable orchestrator or orchestrator engine, the AI agent can be activated to perform the AI task. In some aspects, this determination might be based on the one or more constraints associated with the modeled workflow.

Continuing to operation 1120, the AI agent determines, based at least in part on the current context, to call a Gen AI model to execute at least one activity of the AI task. The Gen AI model (e.g., a LLM) used by the AI agent is defined and specified for the AI agent during the design time. A prompt to be provided to the LLM by the AI agent might be derived from information known to the AI agent, including at least attributes of the AI task and the AI agent. However, additional information related to the current context of the workflow process; constraints and guardrails associated with the task(s) and activities of the workflow process; information related to other AI tasks previously interacted with and/or available for interaction and execution; and information regarding other systems, applications, services and interfaces, etc. may be used to determine the prompt

In response to receiving a result from the LLM, the AI agent can further determine at operation 1125 at least one of a next action to perform towards an achievement of the desired result of the workflow process. The AI agent might use the LLM result, alone or in combination with other information, activities, and actions, to the determine the next action to perform.

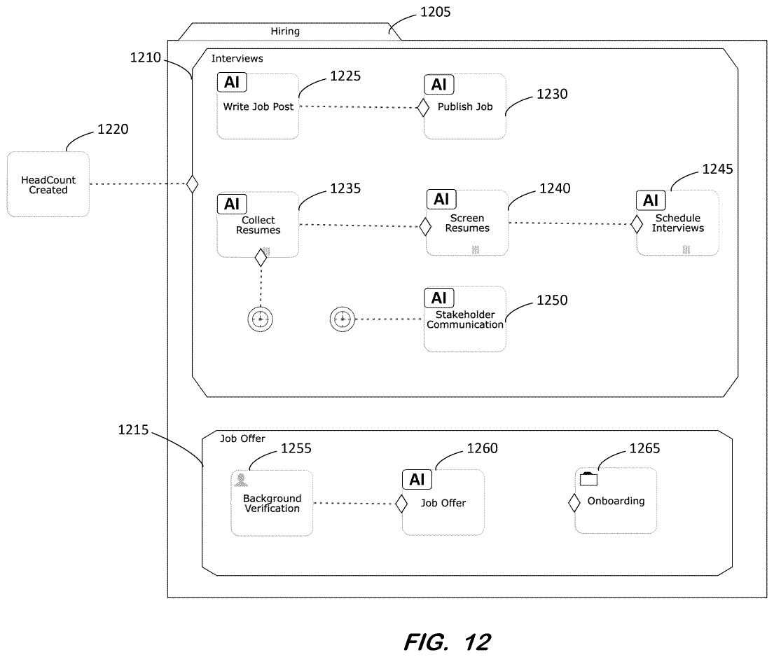

FIG. 12 is an illustrative representation of an agentic workflow process 1205, in accordance with an example embodiment herein. In particular, process 1205 represents some aspects of a hiring process that includes two main processes, including an interviewing process 1210 and a job offer 1215. Each of the interviewing process and the job offering stages of the hiring process 1205 includes multiple tasks. For example, the interviewing process 1210 performs a number of task in response to receiving head count 1220. The head count might be generated by a person or some other entity, including in some instances an automated process. In the present example, receiving the headcount is a trigger event for initiating the interviewing process 1210. Defined tasks for the interviewing process includes AI task 1225 to write a job post based on requirements for the job and AI task 1230 to publish the job post. After the job post is published, resumes may be received from job applicants via one or more channels. AI task 1235 collects the submitted resumes and AI task 1240 screens the resumes to determine which job applicant(s) to interview. Interviews are scheduled by AI task 1245.

The collection, screening, and scheduling of interviews tasks may be repeated. At some point, a job offer may be extended to a job applicant, a task that can be performed by AI task 1260. In some instances, HR personnel performs a background check task 1255 and starts the onboarding process 1265. In the example of FIG. 12, each of the interview tasks can be defined as AI tasks that can be performed by AI agents assigned to the respective AI tasks. As illustrated, the job offer portion of the hiring process can include interactions between AI tasks and non-AI (i.e., conventional) tasks.

In some aspects, the process of FIG. 12 includes or otherwise encounters a number of ad-hoc activities. For example, resume collection may continue and/or resume while previously collected resumes are being screened and job applicants are being scheduled for interviews. Also, AI task 1250 involving communicating with various stakeholders may occur at different times to update those entities. Within the system, the AI tasks 1225, 1230, 1235, 1240, 1245, 1250, and 1260 and the roles of the entities to perform those tasks (e.g., AI agents assigned to each of the AI tasks) are defined.

In the present example, the hiring process is accomplished automatically by AI agents (not shown) and AI tasks 1225, 1230, 1235, 1240, 1245, 1250, and 1260. Each AI agent has a specifically defined role. For example, there are three AI agents corresponding to the AI tasks 1235, 1240, and 1245 where a first AI agent collects the resumes, another AI agent screens the collected resumes, and the third AI agent schedules the interviews.

In accordance with other aspects of the present disclosure, a “case runtime” herein (e.g., FIG. 3, case runtime 320) might, at any point in time, determine which activities to “activate”. For example, after being informed of the hiring process initiation, the case runtime might activate “collect resume” AI task 1235. However, once a certain threshold of resumes are collected, the case runtime might then activate the “screen resume” AI task 1240 which in turn activates the AI agent assigned AI task 1240. Furthermore, in response to the system recognizing, for example, that three resumes are suitable for interview, the AI agent assigned AI task 1245 is activated to schedule interviews with the corresponding job applicants.

Referencing FIG. 3 in light of the present example, case orchestrator 325 is aware of which activities are executing as well as the impact of that activity (i.e., the output of activities in this example, including the collection of resumes, etc.). In the example of FIG. 12, case runtime 320 by virtue of orchestrator 325 can have full knowledge of, for example, what stage different activities are currently at and the state of the documents related to the workflow process (e.g., job posting(s), collected resumes, etc.). Accordingly, the case orchestrator can intelligently and efficiently activate and suspend AI agents as needed based on the determined context and activity stages so that the hiring process is executing in an autonomous manner.

As previously noted, the orchestrator monitors the activities and status of the AI agents and also the state of relevant documents. Accordingly, for the example hiring process of FIG. 12, the relevant documents include, at least, resumes and the job posting document (other documents might exist and be relevant to the hiring process).

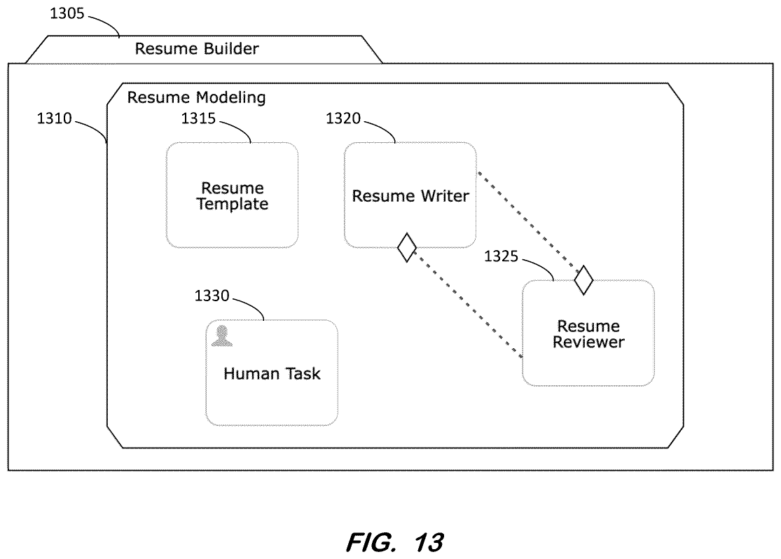

FIG. 13 is an illustrative representation of an agentic workflow process 1305 including aspects related to a document (e.g., resume) drafting process, in accordance with an example embodiment herein. In some aspects, the workflow process represented in FIG. 13 is similar to the example document drafting process introduced in conjunction with the flow pattern depicted in FIG. 8. In the example of FIG. 13, a graphical representation of a modeled process is depicted at 1310. The modeled process includes a “resume writer” AI task 1320, a “resume reviewer” AI task 1325, a “resume template” tool 1315, and a human task 1330.

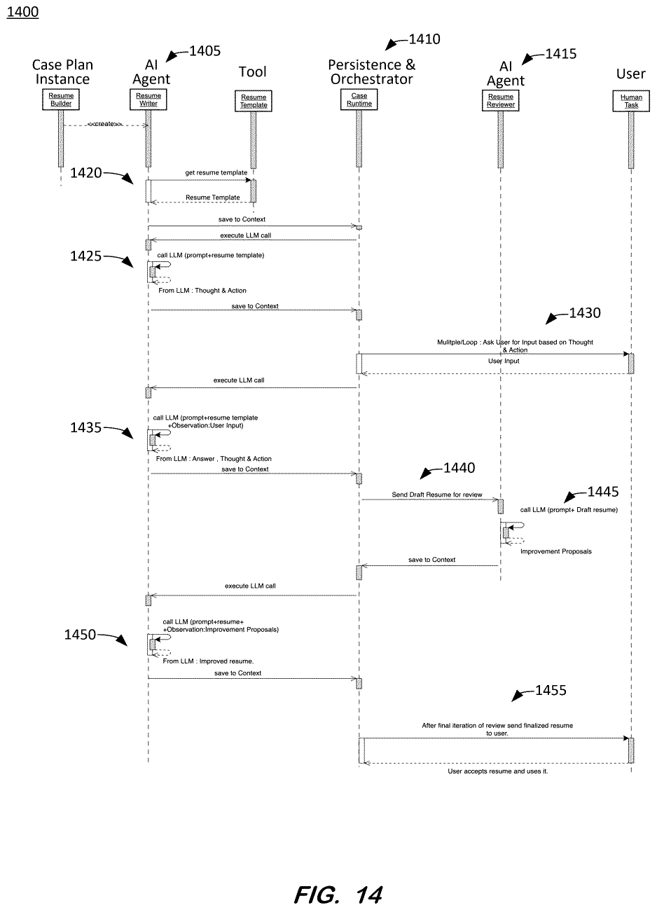

Workflow process 1305 may be understood with further reference to FIG. 14, wherein FIG. 14 is an illustrative sequence diagram 1400 for the agentic workflow of FIG. 13, in accordance with an example embodiment herein. Sequence diagram 1400 illustrates a sequential flow of activities associated with executing an instance of the workflow process 1305. As seen in FIG. 14, an execution of an instantiation of the “resume builder” process triggers AI agent 1405 assigned to the “resume writer” AI task 1320 to request and receive a resume template at 1420 from the “resume template” tool 1315. The interaction between AI agent 1405 and the “resume template” tool is saved to a persistence associated with the orchestrator entity 1410. At 1425, AI agent 1405 executes a call to its specified LLM with a prompt and the resume template. The reply from the LLM is saved as part of the context for the workflow process 1305 to the persistence of orchestrator 1410. At 1430, input is solicited from the user as part of the defined human task 1330, based on the reply received from the LLM. A reply from the user is saved to the persistence of orchestrator 1410 and further passed to AI agent 1405 where the AI agent executes another LLM call at 1435 using a prompt comprising information derived from the current context and the reply from the user to generate a draft resume. The draft resume is saved to the persistence of the orchestrator and further passed at 1440 to AI agent 1415 that is assigned to the “resume reviewer” AI task 1325. Thereafter, AI agent 1415 executes a LLM call at 1445 using a prompt generated based on the current context (as tranced and maintained by the orchestrator and a RAG agent, not shown in FIG. 14). AI agent 1415 executes the LLM call to generate proposed improvements to the draft resume. The proposed improvements and activities of AI agent 1415 are saved by the orchestrator. The proposed resume improvements are passed to AI agent 1405, as directed by the orchestrator, and used by AI agent 1405 to determine a prompt for another LLM call at 1450 that is intended to further revise and improve the resume document. The revised resume document from the LLM is saved by the orchestrator. The resume writing and resume review executions may be repeated a number of times in a manner similar to that described above. In response to a final iteration of the document drafting and document reviewing tasks, the final version of the resume is passed to the user for approval (or rejection), where the user's acceptance (or rejection) of the final resume draft is saved by the orchestrator at 1455. In this manner, all information including activities and actions of the different entities (e.g., AI agents 1405 and 1415, as well as user the user) are fully captured and persisted autonomously.

Sequence diagram 1400 highlights some of the features of the present disclosure, though not all aspects and features herein. For example, aspects such as the actions executed by an AI transformer to facilitate communication between the AI agents and the human task are not explicitly shown in FIG. 14 although such actions might be performed consistent with other aspects and features herein.

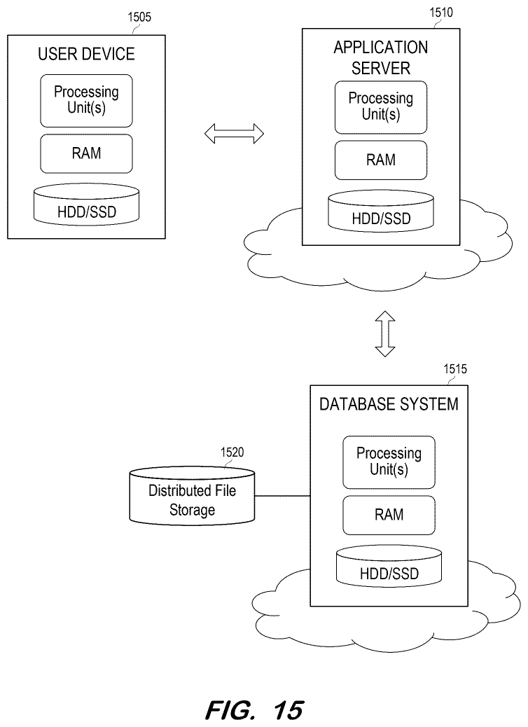

FIG. 15 illustrates a cloud-based database deployment according to some embodiments. The illustrated components may reside in one or more public clouds providing self-service and immediate provisioning, autoscaling, security, compliance and identity management features. User device 1505 may interact with applications executing on application server 1510, for example via a Web Browser executing on user device 1505, in order to create, read, update and delete data managed by database system 1515 and persisted in distributed file storage 1520. Database system 1515 may store data and may execute processes as described herein, including operations to execute an agentic workflow process. Application server 1510 and/or database system 1515 may comprise cloud-based compute resources, such as virtual machines, allocated by a public cloud provider that provides a CMMN-like service having some features and attributes that are evolved, extended, or otherwise configured to support the AI agents, AI tasks, and other features of an agentic workflow disclosed herein. As such, application server 1510 and database system 1515 may exhibit demand-based elasticity.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

Embodiments disclosed herein are solely for the purpose of illustration. Those in the art will recognize other embodiments may be practiced with modifications and alterations to that described above.

What is claimed is:

1. A computer-implemented method, the method comprising:
receiving a signal to initiate execution of a modeled workflow to achieve a specified result, the modeled workflow including at least one artificial intelligence (AI) task to perform at least one activity towards the result and the AI task being assigned to an artificial intelligence (AI) agent, each AI task being defined, at least in part, by a parameterized goal attribute that specifies a scope of the goal;
determining a current context for the modeled workflow, the context representing one or more of a lifecycle of the modeled workflow and a state associated with the modeled workflow;
determining, based on one or more constraints associated with the modeled workflow, whether to call the AI agent to execute the AI task;
determining by the AI agent, based at least in part on the current context, to call a large language model (LLM) to execute the at least one activity of the AI task, a prompt provided as an input to the LLM being derived from at least attributes of the AI Task and the AI agent; and
determining by the AI agent, based at least in part on a result of the call to the LLM, at least one of a next action to perform towards an achievement of the result.

2. The method of claim 1, wherein the signal to initiate execution of the modeled workflow is received in response to at least one of a user input and an Application Programming Interface (API).

3. The method of claim 1, wherein the determining of the current context for the modeled workflow includes a retrieval of contextual information related to the modeled workflow from a persistence.

4. The method of claim 1, wherein the at least one next action includes at least one of a collaboration with another AI task, a collaboration with a non-AI task, and an exit from the modeled workflow.

5. The method of claim 1, further comprising:
tracking interactions and messages between the AI agent and the AI task, interactions and messages between the AI agent and other AI agents, interactions and messages between the AI agent and non-AI agents;
storing the tracked interactions and messages in a persistence; and
updating, based at least in part on the tracked interactions and messages, the context of the modeled workflow.

6. The method of claim 5, wherein the tracking is performed by an AI agent configured to call a LLM model and use a result from the LLM model to achieve the tracking.

7. The method of claim 1, in response to the AI agent determining the next action to perform, further comprising:
determining an updated current context for the modeled workflow, the updated current context including an update to at least one of the lifecycle of the modeled workflow and the state associated with the modeled workflow;
determining to call a second AI agent to execute a second AI task, the second AI task being assigned to the second AI agent;
determining by the second AI agent, based at least in part on the updated current context, to call the LLM to achieve at least one activity of the second AI task, a prompt provided as an input to the LLM being derived from at least attributes of the second AI Task and the second AI agent; and
determining by the second AI agent, based at least in part on a result of the call to the LLM by the second AI agent, at least one of a next action to perform towards achievement of the goal.

8. The method of claim 1, further comprising:
receiving the result of the call to the LLM by the AI agent, the result being configured in a first interface format; and
transforming, in response to the AI agent determining the next action to perform, the result from the first interface format to a second interface format, the second interface format being compatible with an input interface for the determined next action.

9. A system comprising:
at least one programmable processor; and
a non-transitory machine-readable medium storing instructions that, when executed by the at least one programmable processor, cause the at least one programmable processor to perform operations comprising:
receiving a signal to initiate execution of a modeled workflow to achieve a specified result, the modeled workflow including at least one artificial intelligence (AI) task to perform at least one activity towards the result and the AI task being assigned to an artificial intelligence (AI) agent, each AI task being defined, at least in part, by a parameterized goal attribute that specifies a scope of the goal;
determining a current context for the modeled workflow, the context representing one or more of a lifecycle of the modeled workflow and a state associated with the modeled workflow;
determining, based on one or more constraints associated with the modeled workflow, whether to call the AI agent to execute the AI task;
determining by the AI agent, based at least in part on the current context, to call a large language model (LLM) to execute the at least one activity of the AI task, a prompt provided as an input to the LLM being derived from at least attributes of the AI task and the AI agent; and
determining by the AI agent, based at least in part on a result of the call to the LLM, at least one of a next action to perform towards an achievement of the result.

10. The system of claim 9, wherein the signal to initiate execution of the modeled workflow is received in response to at least one of a user input and an Application Programming Interface (API).

11. The system of claim 9, wherein the determining of the current context for the modeled workflow includes a retrieval of contextual information related to the modeled workflow from a persistence layer.

12. The system of claim 9, wherein the at least one next action includes at least one of a collaboration with another AI task, a collaboration with a non-AI task, and an exit from the modeled workflow.

13. The system of claim 9, further comprising:
tracking interactions and messages between the AI agent and the AI task, interactions and messages between the AI agent and other AI agents, interactions and messages between the AI agent and non-AI agents;
storing the tracked interactions and messages in a persistence; and
updating, based at least in part on the tracked interactions and messages, the context of the modeled workflow.

14. The system of claim 9, in response to the AI agent determining the next action to perform, further comprising:
determining an updated current context for the modeled workflow, the updated current context including an update to at least one of the lifecycle of the modeled workflow and the state associated with the modeled workflow;
determining to call a second AI agent to execute a second AI task, the second AI task being assigned to the second AI agent;
determining by the second AI agent, based at least in part on the updated current context, to call the LLM to achieve at least one activity of the second AI task, a prompt provided as an input to the LLM being derived from at least attributes of the second AI Task and the second AI agent; and
determining by the second AI agent, based at least in part on a result of the call to the LLM by the second AI agent, at least one of a next action to perform towards achievement of the goal.

15. A non-transitory, computer readable medium storing instructions, which when executed by at least one processor cause a computer to perform a method comprising:
receiving a signal to initiate execution of a modeled workflow to achieve a specified result, the modeled workflow including at least one artificial intelligence (AI) task to perform at least one activity towards the result and the AI task being assigned to an artificial intelligence (AI) agent, each AI task being defined, at least in part, by a parameterized goal attribute that specifies a scope of the goal;
determining a current context for the modeled workflow, the context representing one or more of a lifecycle of the modeled workflow and a state associated with the modeled workflow;
determining, based on one or more constraints associated with the modeled workflow, whether to call the AI agent to execute the AI task;
determining by the AI agent, based at least in part on the current context, to call a large language model (LLM) to execute the at least one activity of the AI task, a prompt provided as an input to the LLM model being derived from at least attributes of the AI task and the AI agent; and
determining by the AI agent, based at least in part on a result of the call to the LLM model, at least one of a next action to perform towards an achievement of the result.

16. The medium of claim 15, wherein the signal to initiate execution of the modeled workflow is received in response to at least one of a user input and an Application Programming Interface (API).

17. The medium of claim 15, wherein the determining of the current context for the modeled workflow includes a retrieval of contextual information related to the modeled workflow from a persistence layer.

18. The medium of claim 15, wherein the at least one next action includes at least one of a collaboration with another AI task, a collaboration with a non-AI task, and an exit from the modeled workflow.

19. The medium of claim 15, further comprising:
tracking interactions and messages between the AI agent and the AI task, interactions and messages between the AI agent and other AI agents, interactions and messages between the AI agent and non-AI agents;
storing the tracked interactions and messages in a persistence; and
updating, based at least in part on the tracked interactions and messages, the context of the modeled workflow.

20. The medium of claim 15, in response to the AI agent determining the next action to perform, further comprising:
determining an updated current context for the modeled workflow, the updated current context including an update to at least one of the lifecycle of the modeled workflow and the state associated with the modeled workflow;
determining to call a second AI agent to execute a second AI task, the second AI task being assigned to the second AI agent;
determining by the second AI agent, based at least in part on the updated current context, to call the LLM model to achieve at least one activity of the second AI task, a prompt provided as an input to the model being derived from at least attributes of the second AI Task and the second AI agent; and
determining by the second AI agent, based at least in part on a result of the call to the LLM model by the second AI agent, at least one of a next action to perform towards achievement of the goal.
